(19) United States
(12) Patent Application Publication
(10) Pub. No.: US 2024/0420234 A1
(43) Pub. Date: Dec. 19, 2024

(54) CONTINUOUSLY UPDATED MACHINE LEARNING MODELS

(71) Applicant: Arta Tech Pte. Ltd., Singapore (SG)

(72) Inventors: Chirag Yagnik, Los Altos, CA (US); Alok Saxena, Dayton, NJ (US)

(21) Appl. No.: 18/744,612

(22) Filed: Jun. 15, 2024

Related U.S. Application Data
(60) Provisional application No. 63/521,316, filed on Jun. 15, 2023.
(60) Provisional application No. 63/584,738, filed on Sep. 22, 2023.

(51) Int. Cl. G06Q 40/04; G06Q 40/06

(52) U.S. Cl. CPC G06Q 40/04; G06Q 40/06

(57) ABSTRACT

In an embodiment, a one or more non-transitory computer-readable storage media includes receiving account specifications, training a machine-learning model using training data derived from the account specifications to produce a trained machine-learning model capable of outputting a recommendation of a particular asset portfolio, determining an asset portfolio by inputting a particular account specification into the machine-learning model, determining a performance metric for the asset portfolio based on synthetic data and historic data, determining a reference performance metric based on a reference asset portfolio and the synthetic and historic data, comparing the performance metric for the asset portfolio with the reference performance metric to result in a decision of whether to re-train the machine-learning model, re-training the machine-learning model based on updated training data and the synthetic and historic data, automatically executing trades for an updated asset portfolio determined by the re-trained machine-learning model, and repeating the re-training continuously based on a specified frequency or timing.

### BENEFIT CLAIM

This application claims the benefit under 35 U.S.C. § 119 (e) of provisional application 63/521,316, filed Jun. 15, 2023, and provisional application 63/584,738, filed Sep. 22, 2023, the entire contents of which are hereby incorporated by reference for all purposes as if fully set forth herein.

### COPYRIGHT NOTICE

A portion of this patent document's disclosure contains material subject to copyright protection. The copyright owner has no objection to the facsimile reproduction by anyone of the patent document or the patent disclosure, as it appears in the Patent and Trademark Office patent file or records, but otherwise reserves all copyright or rights. @ 2022-2023 Arta Finance, Inc.

### TECHNICAL FIELD

One technical field of the present disclosure is the computer-implemented optimization of machine-learning models.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by their inclusion in this section.

Optimization of machine-learning models refers to assessing the accuracy of machine-learning models to predict, recommend, or classify items. Many domains of industrial and technical activity need automated ways to measure the effectiveness of a trained machine-learning model against the performance of other systems or data that represent idealized or preferred performance. Optimization differs from validation by assessing the best performance of the machine-learning models rather than whether a particular model execution is valid given the training data.

### SUMMARY

The appended claims may serve as a summary of the invention.

### BRIEF DESCRIPTION OF THE DRAWINGS

In the drawings:

FIG. 1A illustrates an example of rebalancing by an automated advisor.

FIG. 1B illustrates an example of rebalancing and reallocation by the embodiments disclosed herein.

FIG. 2A illustrates an example method for asset portfolio construction.

FIG. 2B illustrates another example method for asset portfolio construction.

FIG. 3 illustrates an example method for determining a specification for a portfolio account associated with a user.

FIG. 4 illustrates an example flow diagram for determining an asset portfolio for the portfolio account based on the specification.

FIG. 5 illustrates an example flow diagram for generating a portfolio model.

FIG. 6 illustrates an example flow diagram for tracking portfolio account history.

FIG. 7 illustrates an example method for continuously re-training the portfolio model.

FIG. 8 illustrates a computer system with which one embodiment could be implemented.

### DETAILED DESCRIPTION

### 1. General Overview

### 1.1 Terminology and Organization

In the following description, for the purposes of explanation, numerous specific details are set forth to provide a thorough understanding of the present invention. It will be apparent, however, that the present invention may be practiced without these specific details. In other instances, well-known structures and devices are shown in block diagram form to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail outlined in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices that are described as in communication with each other need not be in continuous communication with each other unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to fully illustrate one or more aspects of the inventions. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or occurrences, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more of the inventions need not include the device itself. Techniques and mechanisms described or referenced herein will sometimes be described in singular form for clarity. However, it should be noted that particular embodiments include multiple iterations of a technique or multiple manifestations of a mechanism unless noted otherwise. Process descriptions or blocks in figures should be understood as representing modules, segments, or portions of code that include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 1.2 Overview of Example Embodiments

Example embodiments encompass the subject matter of the following numbered clauses:

1. A computer-implemented method executed at a computer and comprising: receiving a plurality of account specifications; training a machine-learning model using training data derived from the account specifications to produce a trained machine-learning model capable of outputting a recommendation of a particular asset portfolio; determining an asset portfolio by inputting a particular account specification into the machine-learning model; determining a performance metric for the asset portfolio based on synthetic data and historic data associated with a plurality of assets; determining a reference performance metric based on a reference asset portfolio and the synthetic and historic data; comparing the performance metric for the asset portfolio with the reference performance metric to result in a decision of whether to re-train the machine-learning model; re-training the machine-learning model based on updated training data and the synthetic and historic data; automatically executing one or more trades for an updated asset portfolio determined by the re-trained machine-learning model; and repeating the re-training of the machine-learning model continuously based on a specified frequency or timing.

2. The computer-implemented method of clause 1, wherein each account specification comprises one or more of an objective, an uncertainty parameter, an account setting, a user preference, a candidate asset, model information associated with the machine-learning model, a reallocation frequency, a rebalancing frequency, or a tax harvesting goal.

3. The computer-implemented method of clause 1, wherein each account specification is associated with a time.

4. The computer-implemented method of clause 1, wherein the asset portfolio comprises one or more assets, each of the assets being associated with one or more of a weight value, a monetary value, an asset type, an asset identifier, a factor, or a factor value.

5. The computer-implemented method of clause 4 further comprising: determining a plurality of candidate assets based on one or more objectives and one or more criteria; and selecting the one or more assets from the plurality of candidate assets.

6. The computer-implemented method of clause 1 further comprising: generating one or more factors based on the synthetic and historic data; and determining the performance metric for the asset portfolio and the reference performance metric based on the one or more factors.

7. The computer-implemented method of clause 1, wherein the synthetic data comprises synthetic market data comprising realizations of market data that mimic overall characteristics of real market data, wherein the realizations of market data have been benchmarked to a time period, and wherein the realizations of market data have different distributions compared to the real market data.

8. The computer-implemented method of clause 1, wherein the performance metric comprises one or more of the Sharpe ratio, Sortino ratio, Treynor ratio, Calmar ratio, Martin ratio, upside potential ratio, information ratio, or absolute return.

9. The computer-implemented method of clause 1 further comprising comparing the performance metric for the asset portfolio with the reference performance metric to result in a decision to re-train the machine-learning model based on the reference performance exceeding the performance metric for the asset portfolio.

10. The computer-implemented method of clause 1 further comprising: comparing the performance metric for the asset portfolio with the reference performance metric based on the performance metric for the asset portfolio exceeding the reference performance metric to result in a decision to not re-train the machine-learning model; and selecting the asset portfolio for executing the one or more trades.

11. The computer-implemented method of clause 1 further comprising determining the specified frequency or timing based on the particular account specification.

12. The computer-implemented method of clause 1 further comprising: determining one or more objectives associated with the particular account specification; and comparing the asset portfolio with the reference asset portfolio based on the objectives to result in a decision of whether to re-train the machine-learning model.

13. The computer-implemented method of clause 1 further comprising: determining a performance distribution associated with the asset portfolio; determining a reference performance distribution associated with the reference asset portfolio; and comparing the performance distribution associated with the asset portfolio with the reference performance distribution to result in a decision of whether to re-train the machine-learning model.

In one embodiment, the technology disclosed herein can use continuous machine-learning model optimization to generate artificial intelligence (AI) managed portfolios. An embodiment can define portfolios to deliver better risk-adjusted returns by novel means of using AI and machine-learning expertise together with the personalization one would expect from a dedicated financial advisor, performance from the technology-driven methodology used by quantitative hedge funds, and simplicity and low price of passive investments. One embodiment leverages investment methods of quant funds and can apply machine-learning models trained over vast market and financial data sets using a learning methodology to determine the right allocations of the assets in the portfolio at a particular time. Determining the allocations at a particular time is important because as the market changes, for example, from a bull to a bear market, the allocation may need to change to approach an efficient frontier. Rebalancing to a fixed allocation may be insufficient.

Embodiments differ from index-tracking exchange-traded funds (ETFs) and robo-advisors. For an index-tracking ETF, determining the allocations for a portfolio may comprise tracking the index with some tracking error due to fees and operating expenses. Take $SPY, which tracks the S&P 500 (a market cap-weighted index), for an example. In this ETF, the allocations of the various assets (such as shares of $GOOG, $APPL, and so on) map to their relative market capitalization in the S&P 500. The S&P 500 reviews its index quarterly and changes its mix of stocks in companies depending on various criteria, including market cap, profitability, and public trading availability. When a stock is included or excluded from the S&P 500, $SPY may buy or sell the necessary stocks to return to the same allocation. Since all an index-tracking ETF needs to do is follow these indexes, these ETFs may have low operation costs. Although they are cost-effective, these ETFs may have a few drawbacks. The ETF may go up and down with the index with no mitigation of the downside or ability to capture the upside. In addition, most investors may want to diversify with more than just one of these ETFs, but allocating and rebalancing between them may require self-management or a financial advisor.

Tracking the market by index funds may cause investors to lose out when markets go up and down. Indexes may rebalance at predictable intervals and have well-known criteria for inclusion. There may be a gap between when a stock becomes eligible to be included (or excluded) and when the index is updated, which is the same for index funds. For example, the addition of TSLA to the S&P 500 was known a few weeks before it was added, leading to many market participants driving up the stock's price. This is bad for investors of SPY because when TSLA was finally added, they effectively ended up paying a higher price for TSLA than what they would have paid. Over time many gaps like this could add up. Savvy investors know this kind of gap, and those who can afford it may monitor the markets and have teams adjust their portfolios accordingly. Compared to index-tracking ETFs, the embodiments disclosed herein may bring similar sophistication at a lower cost.

The investment team guiding a robo-advisor may determine a portfolio's allocation between various assets or asset classes, which may then be mapped to a label that describes what risk level they are accepting. For example, the risk level may be from 1 to 10, with 10 being the highest risk level they offer. For most robo-advisors, these allocations may be determined by investment teams or their chief information officer and may not change often, if ever.

### 2. Structural & Functional Overview

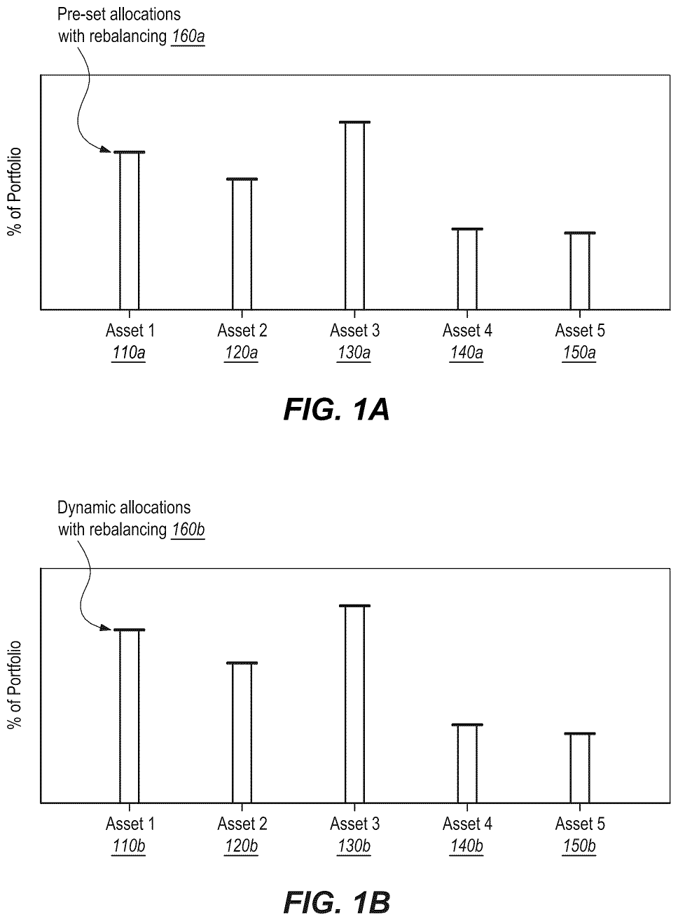

FIG. 1A illustrates an example of rebalancing an investment portfolio using a robo-advisor. As shown in FIG. 1A, the asset portfolio may include a first asset 110a, a second asset 120a, a third asset 130a, a fourth asset 140a, and a fifth asset 150a. As the prices of the stocks and bonds change and deviate from the pre-set allocations, the robo-advisor may rebalance the portfolio to return to the original, shown as pre-set allocations with rebalancing 160a in FIG. 1A. Some robo-advisors may be able to rebalance as often as daily and even use tax loss harvesting. Although some performance is gained through more regular rebalancing and tax loss harvesting, the allocation methodologies may be static and determined by teams of human investment managers and subject to all the disadvantages that come with human decision-making, e.g., emotions and bias, low responsiveness, and limited capacity to analyze data.

In sharp contrast, an embodiment of the present disclosure uses systematic and algorithmic investment methodologies. Important differences arise from how the embodiments disclosed herein apply machine learning. The embodiments disclosed herein may be used by everyday investors and, therefore, optimized for long-term systematic risk management and better risk-adjusted returns. By contrast, quant funds often aim for very high returns while taking on more risk or large amounts of leverage. Consequently, embodiments disclosed herein may avoid high-frequency trading or statistical arbitrage, commonly used by quant funds. In addition, the embodiments disclosed herein may operate on a per-portfolio basis, so an investor can have multiple portfolios, each with its own settings. Therefore, an investor can create a more personalized and flexible financial plan for themselves.

An investor may also directly own the assets in their portfolios, which means any tax advantages from the methodologies or the assets flow straight to the investor. For example, US treasuries may not attract US state taxes. As a result, because the investor owns the underlying assets, the investor may benefit directly when they buy certain portfolios generated based on the embodiments disclosed herein. By contrast, quant funds may operate one fund where an investor's share is mixed with other investors. Running each investor's own portfolio and the use of machine learning enables the embodiments disclosed herein to provide deep personalization at an individual level. In an embodiment, investors can express their investment objectives and risk preferences. In another embodiment, investors may specify sector or geographic preference.

Based on machine-learning models, market conditions, and changing investor needs and preferences, the embodiments disclosed herein can change assets and allocations frequently and rebalance as often as daily. The embodiments disclosed herein may get the portfolio closer to the theoretically efficient frontier, resulting in better risk-adjusted returns. FIG. 1B illustrates an example of rebalancing and reallocation under the automatic control of an embodiment. As shown in FIG. 1B, the asset portfolio may include a first asset 110b, a second asset 120b, a third asset 130b, a fourth asset 140b, and a fifth asset 150b. The embodiments disclosed herein may perform dynamic allocations with rebalancing 160b.

The machine-learning models of an embodiment may be trained on the vast market, macroeconomic, and company financial datasets. The embodiments disclosed herein can be tested rigorously, e.g., on out-of-sample data, against hypothetical scenarios to simulate different market conditions, against industry standard factor models, and in the actual market. While in operation, the embodiments disclosed herein may be systematically monitored for safety and controls under human expert supervision. The embodiments disclosed herein may also be regularly reviewed to ensure they perform as expected. In an embodiment, the embodiments disclosed herein can be used to trade highly liquid ETFs. In another embodiment, the embodiments disclosed herein can be used to trade individual stocks. The embodiments disclosed herein may continually improve with model upgrades, asset universe changes, or additional data (e.g., risk or factor data from industry providers).

Compared to most self-managed accounts, robo-advisors, most human financial advisors, index-tracking ETFs, typical quant funds, and private bank discretionary portfolios, the embodiments disclosed herein have the following advantages. The embodiments disclosed herein are powered by AI and machine learning. The embodiments disclosed herein can dynamically change the allocations as often as monthly and rebalance as often as daily. The embodiments disclosed herein are data-driven and capable of automated decision-making. In addition, the embodiments disclosed herein can utilize advanced/sophisticated/automated tax loss harvesting. The embodiments disclosed herein can also track and manage risk levels and control personalized risks. The embodiments disclosed herein can provide a high level of user control. The embodiments disclosed herein can also be personalized and responsive to life changes, investment preferences, and/or changing market conditions. The assets in the portfolio are owned directly and are not commingled. The embodiments disclosed herein have automated careful use of leverage, derivatives, low fees, and low minimums. In addition, a retirement account is eligible. The embodiments disclosed herein are available to everyone, including non-accredited investors.

### 2.1 Overview of Asset Portfolio Determination

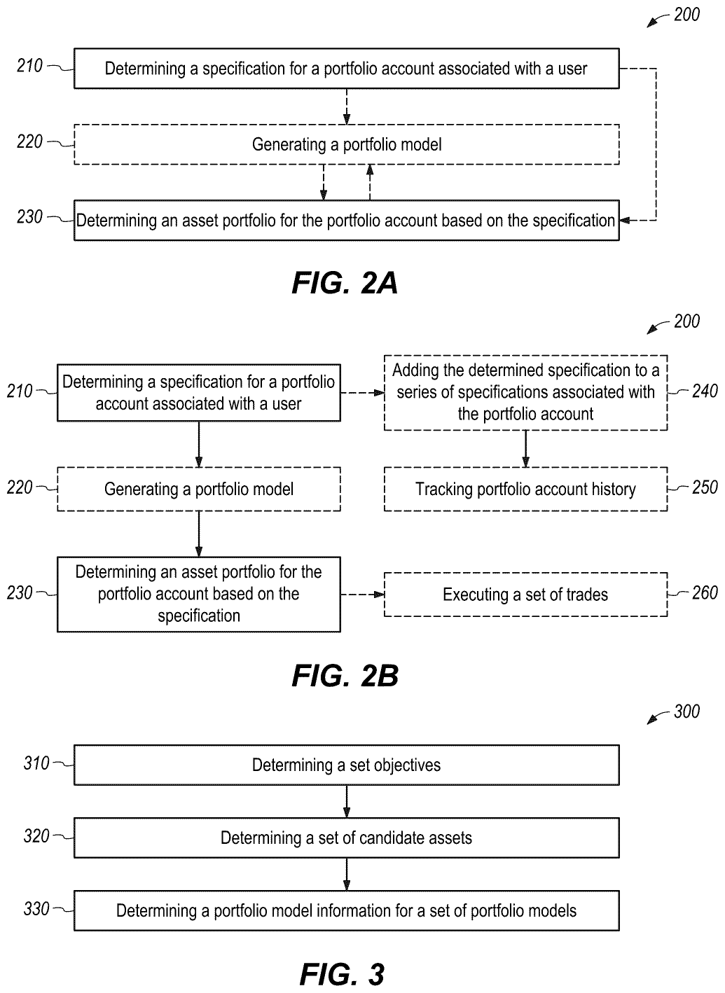

FIG. 2A illustrates an example computer-implemented method of asset portfolio construction. Each step of FIG. 2A can be implemented under stored program control using software prepared using any appropriate programming language and executed using a computer system. In an embodiment, the computer system comprises components implemented partially by hardware at one or more computing devices, such as one or more hardware processors executing stored program instructions stored in one or more memories for performing the functions described herein. In other words, all functions described herein are intended to indicate operations performed using programming in a special or general-purpose computer in various embodiments. The drawing figures illustrate only one of many possible arrangements of components configured to execute the programming described herein. Other arrangements may include fewer or different components, and the division of work between the components may vary depending on the arrangement.

FIG. 2A, and the other drawing figures and all of the description and claims in this disclosure, are intended to present, disclose and claim a technical system and technical methods in which specially programmed computers, using a special-purpose distributed computer system design, execute functions that have not been available before to provide a practical application of computing technology to the problem of continuous training, re-training, and optimization of machine-learning models. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

FIG. 2A and each other flow diagram herein is intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

In the example method 200, at step 210, a computer system may determine a specification for a portfolio account associated with a user. Optionally, at step 220, the computer system may execute and generate a portfolio model. At step 230, the computer system may determine an asset portfolio for the portfolio account based on the specification. Although this disclosure describes and illustrates an example method for asset portfolio construction including the particular steps of the method of FIG. 2A, this disclosure contemplates any suitable method for asset portfolio construction, including any suitable steps, which may include all, some, or none of the steps of the method of FIG. 2A, where appropriate.

Method 200 can function to determine an asset portfolio (e.g., a collection of assets) for a user based on a specification (e.g., what are the user's objective(s), what are the candidate assets, which portfolio model(s) to use, etc.). However, the method 200 can have any other suitable functionality.

FIG. 2B illustrates another example method 200 for asset portfolio construction. The computer system may first receive one or more objectives from a user (e.g., via a user interface). As an example and not by way of limitation, an objective can be a risk profile objective, a sector exposure objective, etc.). As illustrated in FIG. 2B, at step 210, the computer system may determine a specification for a portfolio account associated with the user. As an example, and not by way of limitation, the specification may include one or more objectives, one or more candidate assets, portfolio model information for one or more portfolio models, etc. The computer system may optionally determine a set of candidate assets for the user based on the specification.

At step 220, the computer system may optionally generate a portfolio model. The portfolio model may maximize objectives and output weights that are performant across a distribution of uncertainties. As an example, and not by way of limitation, the portfolio model may be a multi-objective optimization model, a neural network, etc. In some embodiments, to generate the portfolio model, the computer system may optionally generate a set of portfolio models first. The computer system may then select a portfolio model from the set of portfolio models identified in the specification. The computer system may optionally re-train the portfolio model. In an embodiment, re-training of the portfolio model may be in response to changes in financial market conditions such that the portfolio model can consistently achieve the set of objectives.

In another embodiment, re-training of the portfolio model may be based on the produced portfolio's performance as compared to reference portfolios. A model collection specification provides a form of model training “recipe” that defines hyperparameters for how an individual portfolio construction model should be trained. Example values could specify to retrain it every month, use a 4-year lookback period for computing covariance, run optimization model X, etc. An individual trained model itself results from the process above; this is “retrained” in a way that accounts changes in market conditions and user preferences, based on the model collection spec. Running the process above results in target allocations, based on which trades are executed. These result in some performance curve, which is later compared against a reference portfolio.

Examining the produced portfolio's performance as compared to the reference portfolio can cause the system to evolve the model collection specification as opposed to retraining the individual portfolio construction model. For example, the system may opt to switch to using 3-year lookback window instead of 4-year, or to modify the underlying optimization algorithm. Thus, the system is programmed to implement a deeper level of learning new parameters than merely retraining a portfolio construction model based on new market data.

At step 230, the computer system may then determine an asset portfolio (e.g., assets with each asset associated with a weight value) for the portfolio account using the portfolio model based on a set of objectives and a set of candidate assets included in the specification.

At step 240, the computer system may optionally add the determined specification to a series of specifications associated with the portfolio account. At step 250, the computer system may optionally track portfolio account history based on the series of specifications associated with the portfolio account. At step 260, the computer system may optionally execute a set of trades (e.g., buy and/or sell assets) for a current asset portfolio (e.g., for reallocation, for rebalancing, etc.) based on the determined asset portfolio (e.g., asset weights) and/or a change of price for an asset within the current asset portfolio.

In some embodiments, the asset portfolio can be selected for a user's portfolio when the asset portfolio's performance exceeds a reference portfolio's performance (e.g., performance for the current portfolio, a baseline portfolio, etc.). In an embodiment, the computer system may determine the asset portfolio's performance based on performance metrics calculated from a set of asset factors. The computer system may determine that the asset portfolio's performance exceeds a reference portfolio's performance using backtesting, out-of-sample data, and hypothetical scenarios (e.g., wherein the factors are perturbed in a similar manner to major historical market events, randomly perturbed, etc.), and/or other performance evaluation methods.

Although this disclosure describes and illustrates an example method for asset portfolio construction including the steps of the method of FIG. 2B, this disclosure contemplates any suitable method for asset portfolio construction, including any suitable steps, which may include all, some, or none of the steps of the method of FIG. 2B, where appropriate.

### 2.2 Technical Advantages

The embodiments disclosed herein can confer several technical advantages over conventional systems and methods in many domains. One domain, which is not the only domain in which the techniques of the disclosure can be applied, is financial resource management systems. Conventional financial resource management systems may suffer from several drawbacks. For example, conventional advisors don't usually offer much more than automate what a financial portfolio manager might have done. Some investors can cherry-pick from various quant hedge funds and asset managers to create portfolios that outstrip what regular investors can achieve independently. Investors seek the same leading financial technology tuned to individual financial goals. Research over the years in academia can be utilized using the same rigor and technology as these quant hedge funds but be made available to individuals at a lower cost.

First, the embodiments disclosed herein can enable hyper-personalization and customization of an asset portfolio that considers a user's objectives (e.g., risk profile objectives, sector exposure objectives, employer restrictions, etc.). For example, a user can “lean toward” or “lean away” from a particular objective, such as a tech sector exposure (e.g., semiconductors, computers, etc.), risk factor, market type (e.g., emerging market, developed market, domestic market, foreign market, etc.), asset class (e.g., stock, bond, etc.), market capitalization (e.g., small, mid, large, etc.), stock type (e.g., income, growth, etc.), efficiency value, risk value, and/or other objectives. In an example use case, when the user “leans toward” the tech sector exposure, the portfolio model predicts a portfolio that will perform better than a baseline portfolio without personalization if the tech sector performs well relative to a baseline portfolio, and when the user “lean away” from the tech sector exposure, the portfolio model predicts a portfolio that will perform better than a baseline portfolio assuming the tech sector were to crash.

Second, the embodiments disclosed herein can enable diversification and efficiency of an asset portfolio for the user. As a result, for every unit of risk that has been taken, the processes described herein attempt to generate the highest return. Additionally, since a hyper-personalized asset portfolio generally decreases concentrated risk, the risk budget is used more efficiently by identifying assets that diversify the risk of a particular asset. In particular embodiments, a trained portfolio model that optimizes efficiency determines asset weights for an asset portfolio, quantifying the process to generate new asset investment ideas.

Third, the embodiments disclosed herein can enable adaptive weights of assets. In some embodiments, enabling adaptive weights of assets can be accomplished by dynamically redetermining the portfolio allocation (e.g., asset weights) based on the user's objectives, the factors of the set of candidate assets, and/or other information. Conventionally, financial robo-advisers and ETFs may generate asset portfolio recommendations using static weights (e.g., constant weighting between stocks and bonds) for passive investing. Being more active in determining the weights of investments creates more efficiencies from a tail-risk protection perspective. Adaptive weights of assets may allow tailoring of the asset portfolio to be more resilient to large financial market movements (e.g., financial crashes) compared to market tracking portfolios that are typically available.

Fourth, the embodiments disclosed herein can enable a robust learning process to adapt to the non-stationary nature of financial markets (e.g., historically successful strategies will not necessarily remain successful in the future). This is because, within this intelligent ecosystem, when one participant has a good strategy, other participants will react collectively, leading to decay in the performance of strategies that are doing well. This non-stationary nature (e.g., historical performance is not indicative of future performance) may make training a machine-learning-based portfolio model extremely difficult because conventional training methodologies for machine-learning models may assume that historical data represents future data. The embodiments disclosed herein can enhance the learning process to adapt to uncertainties and changing behavior over time through a series of back-testing studies that are first exposed to synthetic data and gradually exposed to real data. Portfolio construction decisions explicitly account for uncertainty or noise in forecasted data. For example, because markets are non-stationary, embodiments use hyperparameters in the machine-learning models that represent how much uncertainty exists in forecasts for expected returns, volatility, and other factors. By running synthetic data studies that involve non-stationary synthetic data, the disclosed system can calibrate these hyperparameters.

This may prevent learning with hindsight bias with the ability to look at data in the future.

Although this disclosure describes particular technical advantages in a particular manner, other suitable technical advantages will be readily apparent to one skilled in the art from the following figures, descriptions, and claims. Moreover, while specific advantages have been enumerated above, various embodiments may include all, some, or none of the enumerated advantages.

### 2.3 Execution and Use of Method

A computer system may execute all or portions of the method 200. The computer system may include a remote computing system (e.g., a platform) but can include and/or alternatively be a local computing system, a third-party computing system, and/or any other suitable one. The remote computing system can be centralized or decentralized. The remote computing system may interface with users directly (e.g., via user interfaces) but can additionally and/or alternatively interface with users indirectly, not interface with users, and/or otherwise interface with users. The remote computing system can interface with external systems (e.g., data sources) using a set of communication mechanisms (e.g., APIs, webhooks, pub/sub architectures, etc.) and/or otherwise interact (e.g., read and/or write data) with external systems. The remote computing system may store specifications but can additionally and/or alternatively store factor values, aggregated data (e.g., aggregated data derived from factor values, etc.), and/or any other suitable information.

In some embodiments, one or more instances of method 200 can be used with one or more users, one or more portfolio accounts, one or more specifications, one or more models (e.g., portfolio model), one or more objectives (e.g., objective type with associated objective value), one or more factors, one or more uncertainty parameters (e.g., confidence intervals), one or more times (e.g., timestamps, time windows, time intervals, etc.), one or more sources (e.g., the data source from which the factor value was received), and/or otherwise repeated.

In an embodiment, method 200 can be used with one or more users via user computers. The user may preferably be an individual but can additionally and/or alternatively be an entity (e.g., a trust, an institution, etc.). The user may be preferably an accredited investor or a qualified purchaser but can additionally and/or alternatively be any other suitable investor. The user can be associated with a user identifier (e.g., a portfolio account number, platform login credentials such as username/password, a user access token, etc.) and/or any other suitable information. The user identifier may be preferably unique to the user but can additionally and/or alternatively be non-unique to the user. Each user can be associated with one or more portfolio accounts (e.g., an AI-managed portfolio account). Each user can be associated with a computing device such as a laptop computer, desktop computer, tablet computer, mobile computing device, or workstation.

In an embodiment, method 200 can be used with one or more portfolio accounts. The portfolio account can be linked to a third-party account (e.g., a bank account, a brokerage account, etc.) or not to a third-party account. The portfolio account may be preferably linked to a third-party account to receive and/or withdraw assets (e.g., cash, equities, fixed income, alternative assets such as cryptocurrency, etc.), but additionally and/or alternatively, the linkage between the portfolio account and the third-party account can provide any other suitable functionality. The portfolio account may be preferably associated with one or more series of specifications but can additionally and/or alternatively be associated with one specification, not be associated with a specification, and/or otherwise associated with a specification. Each specification can be associated with a time series of portfolios (e.g., one portfolio at any given timestep) but can alternatively be associated with no portfolios, a single portfolio, and/or any other suitable number of portfolios. The portfolio account can include one or more asset portfolios. Each asset portfolio can include one or more assets. The asset can be associated with an asset type or not be associated with an asset type. Asset types can include cash, equities, fixed income, and/or any other suitable asset type. Assets can include cash and/or cash equivalents, money market funds, U.S. treasury bills, certificates of deposit (CDs), stocks, dividend payments, bonds, and/or any other suitable asset. The asset can be associated with an asset identifier (e.g., ticker symbol, internal identifier, etc.) or not with an asset identifier. The asset is preferably associated with a weight value (e.g., percentage of total portfolio value) within the portfolio but can additionally and/or alternatively be associated with a monetary value and/or any other suitable value. Each asset can be associated with one or more factors and/or factor values.

In an embodiment, method 200 can be used with one or more factors and/or factor values. Factors can be associated with an asset, a set of assets, relationships between assets, market conditions, and/or any other suitable parameter. The factors may be preferably features extracted from historical data for a set of assets over time (e.g., the time series of data of the asset set) but can additionally or alternatively be extracted from other factors, extracted from market-related information (e.g., news, etc.), and/or otherwise determined. In one embodiment, factors can be identified, selected, and stored based on prompts to a large language model (LLM). For example, an asset's risk exposure could be determined based on prompting an LLM to assess SEC Form 10-K reports, mentions and descriptions of the asset in online networked financial news sources, or through other means.

Examples of factors can include market risk (e.g., sensitivity of investment to overall market movements), size (e.g., risk associated with market capitalization of a company), value (e.g., risk associated with valuation of a company); momentum (e.g., risk associated with a recent price trend of an asset), volatility (e.g., risk associated with volatility or unpredictability of an asset's returns), liquidity (e.g., risk associated with the ease of buying or selling an asset without significantly impacting its price), price-to-earnings ratio, growth, quality (e.g., risk associated with a financial health and quality of a company), yield (e.g., risk associated with a company's dividend yield), term spread (e.g., risk associated with the difference between long term and short term interest rates), credit spread (e.g., risk associated with difference between yields on corporate bonds and government bonds), currency (e.g., risk associated with changes in exchange rates), commodity (e.g., risk associated with changes in commodity prices), country risk (e.g., risk associated with investing in a specific country), inflation (e.g., risk associated with changes in inflation rates), leverage (e.g., risk associated with a company's level of debt), default (risk associated with the likelihood of a company defaulting on its debt obligations), interest rate (e.g., risk associated with changes in interest rates), real estate (e.g., risk associated with real estate investments), industry (e.g., risk associated with specific industries), environmental, social, and governance (e.g., risk associated with a company's environmental, social, and governance practices), illiquidity (e.g., risk associated with trading in illiquid markets), event risk (e.g., risk associated with specific events that can impact an investment's value), systemic risk (e.g., risk associated with broader systemic factors that affect entire markets or the financial system as a whole), model risk (e.g., risk associated with accuracy and reliability of quantitative models used for assessments), political risk (e.g., risk associated with political instability), regulatory risk (e.g., risk associated with changes I regulations that affect the operations and/or profitability of companies and industries), market sentiment (e.g., risk associated with shifts in investor sentiment and market psychology), supply chain risk (e.g., risk associated with disruptions in a company's supply chain), cybersecurity risk (e.g., risk associated with cyber threats and data breaches), technological disruption (e.g., risk associated with technological advancements that can disrupt industries and traditional business models), demographic risk (e.g., risk associated with changes in demographics such as aging populations), geopolitical risk (e.g., risk associated with geopolitical tensions and conflicts), and/or any other suitable factor. The factors can be semantic (e.g., have human meaning) or non-semantic. The factors can be determined by the system, obtained from a third-party system, and/or otherwise determined.

### 2.4 Specification for a Portfolio Account

Determining a specification for a portfolio account associated with a user may function to determine a specification that defines how an asset portfolio is constructed and/or specify a set of goals and/or constraints for the asset portfolio. The specification can include one or more objectives (e.g., objective type, objective values, etc.), one or more candidate assets (e.g., for a static investable universe, for a dynamic investable universe, etc.), portfolio model information (e.g., which portfolio models can be used, how a portfolio model is trained, model inputs and/or model inputs during training and/or inference, etc.) for a set of portfolio models, one or more sub-models (e.g., covariance matrix sub-model) within a portfolio model, one or more factors and/or factor values (e.g., factors associated with a candidate asset, factors associated with relationships between candidate assets, factors associated with market conditions, etc.), uncertainty parameters, portfolio account settings, user preferences (e.g., sector tilt personalization), and/or any other suitable information. The specification can be associated with a time (e.g., timestamp, time window, time interval, etc.) or not be associated with a time.

FIG. 3 illustrates an example method 300 for determining a specification for a portfolio account associated with a user. The method 300 can include the following steps. At step 310, the computer system may determine a set of objectives. At step 320, the computer system may determine a set of candidate assets. At step 330, the computer system may determine portfolio model information for a set of portfolio models.

Determining a set of objectives may determine the asset portfolio's objective(s). Each objective may be associated with an objective type and value but can additionally and/or alternatively be associated with any other suitable parameter. As an example and not by way of limitation, objective types can include risk profile objectives (e.g., target volatility), industry exposure objectives (e.g., technology, healthcare, financials, consumer goods, energy, etc.), sector exposure objectives (e.g., software, hardware, cloud computing, artificial intelligence, etc.), efficiency objectives (e.g., maximizing efficiency), geographic objectives (e.g., domestic, international, continental, regional, etc.), investment style objectives (e.g., value, growth, dividend, non-dividend, etc.), market capitalization objectives (e.g., large-cap, mid cap, small cap, etc.), market index objectives (e.g., market indices such as S&P 500, NASDAQ, Dow Jones Industrial Average, etc.), environmental, social, and governance objectives (e.g., sustainability, ethical practices, corporate governance, etc.), restrictions (e.g., employer restrictions), and/or any other suitable objective types. The objective type may be predetermined but can additionally and/or alternatively be dynamically determined and/or otherwise determined.

Objective values can be numerical (e.g., an integer, a range, a percentage, a decimal, etc.), categorical (e.g., lean away, neutral, lean toward, etc.), Boolean, non-Boolean, and/or any other suitable characteristic. The objective value may be determined manually (e.g., by a user on a user interface), but can additionally and/or alternatively be retrieved from a database, received from a third-party system, predetermined, determined automatically, and/or otherwise determined.

In an embodiment, determining a set of objectives can include manually determining the set of objectives by a user on a user interface. For example, a user enters a percentage (e.g., 70%) for target volatility (e.g., a percentage of the volatility of a market portfolio such as SPY) given a risk volatility range (e.g., 50%-125%) and selects an option (e.g., lean toward) for a technology industry exposure given technology industry exposure options (e.g., lean away, neutral, lean toward, etc.).

In an embodiment, determining a set of objectives can include predetermining maximizing efficiency as an objective of the set of objectives for all specifications.

Although this disclosure describes determining a set of objectives in particular manners, this disclosure contemplates determining a set of objectives in any suitable manner.

Determining a set of candidate assets may function to identify candidate asset(s) to choose from for the asset portfolio. The candidate assets can be static (e.g., partially static, fully static, etc.) and/or dynamic (e.g., partially dynamic, fully dynamic, etc.). When the set of candidate assets is dynamic, the set of candidate assets can change daily, weekly, monthly, quarterly, yearly, and/or at any other suitable frequency. As an example and not by limitation, the set of candidate assets may include the top 5 companies by weighted market cap in a technology sector (e.g., cloud computing), in which the set of candidate assets can change daily. As another example and not by way of limitation, the set of candidate assets includes all companies within the S&P 500, wherein the list of companies within the S&P 500 changes on a quarterly basis (e.g., selected by a committee). However, the set of candidate assets can be otherwise dynamic. The set of candidate assets may be determined based on a set of objectives and/or other criteria (e.g., inclusion criteria, exclusion criteria, etc.) but can additionally and/or alternatively be determined based on user input and/or any other suitable information. Inclusion and/or exclusion criteria can include an asset (e.g., an asset identifier, an asset type, etc.), a market capitalization (e.g., a market cap of a certain size), earnings (e.g., earnings of the most recent quarter, sum of the previous four quarters of earnings, etc.), ownership of shares (e.g., shares of asset owned by the public, shares of asset owned privately, etc.), timing (e.g., at least one year after initial public offering), objectives (e.g., described above such as industry exposure objectives, market index objectives, etc.), financial compliance, and/or any other suitable criteria. The set of candidate assets can be determined manually (e.g., by a user on an interface), automatically (e.g., using a candidate asset model), predetermined, a combination thereof, and/or otherwise determined.

In some embodiments, determining a set of candidate assets can include determining the set of candidate assets based on the set of objectives and/or a set of criteria using a candidate asset model. The candidate asset model may include heuristics but can additionally and/or alternatively include a neural network, a regression, and/or any other suitable model.

In an embodiment, the candidate asset model can include heuristics, wherein the heuristics may determine the set of candidate assets based on a set of criteria (e.g., inclusion criteria, exclusion criteria, etc.) and/or a set of objectives. As an example and not by way of limitation, assets associated with the cloud computing sector may be included in the set of candidate assets when the sector exposure objective for cloud computing is “lean toward” and excluded from the set of candidate assets when the sector objective exposure for cloud computing is “lean away.” Assets associated with a given sector can be assets for companies within the sector, assets influenced by the sector (e.g., shipping companies are associated with the semiconductor sector), and/or any other suitable set of assets. As another example and not by way of limitation, only assets with a majority of shares owned by the public may be included in the set of candidate assets when the set of criteria includes public ownership of shares. As yet another example and not by way of limitation, only assets with positive earnings of the most recent quarter may be included in the set of candidate assets when the set of criteria includes positive earnings. Although this disclosure describes determining the set of candidate assets using heuristics based on particular criteria and/or objectives in particular manners, this disclosure contemplates determining the set of candidate assets using heuristics based on any suitable criteria and/or objectives in any suitable manner.

In another embodiment, the candidate asset model can include a neural network trained to output the set of candidate assets based on the set of objectives as input. As an example and not by way of limitation, the neural network can include a network with multiple output heads, wherein different output heads predict a probability of candidate asset set inclusion for a different asset within a set of assets based on the respective asset's factor values (e.g., current factor values, factor values from an evaluation time window, etc.). Although this disclosure describes the candidate asset model, including particular models, this disclosure contemplates the candidate asset model, including any other suitable model.

In some embodiments, determining a set of candidate assets can include inputting (e.g., selecting, filling in, etc.) the set of candidate assets (e.g., asset identifiers such as ticker symbols) by a user via a user interface. Although this disclosure describes determining the set of candidate assets in a particular manner, this disclosure contemplates determining the set of candidate assets in any suitable manner.

Determining portfolio model information for a set of portfolio models may function to define the portfolio model(s) (e.g., model architecture) that can be used for asset portfolio determination (e.g., in step 230 of FIG. 2A, FIG. 2B). Each portfolio model is preferably a trained portfolio model (e.g., generated in step 220 of FIG. 2A, FIG. 2B) but can alternatively be an untrained portfolio model. The portfolio model information can include which portfolio models can be used (e.g., portfolio model identifier), how a portfolio model is trained and/or re-trained, frequency and/or timing of re-training, model input(s) (e.g., during model training, during model inference), model output(s) (e.g., asset weights), which sub-models (e.g., a covariance matrix sub-model) are used within a portfolio model, and/or any other suitable information. The portfolio model information can be determined based on a set of objectives (e.g., determined in step 310 of FIG. 3), a set of candidate assets (e.g., determined in step 320 of FIG. 3), and/or any other suitable information. As an example and not by way of limitation, the portfolio model information may specify the portfolio model version to be used for asset portfolio construction.

For example, within a given timeframe, the same portfolio model can be used for all specifications (e.g., used to generate all asset portfolios). In a second specific example, the same portfolio model can be used for all specifications (e.g., used to generate all asset portfolios) sharing the same set of objectives (e.g., objective values) within a given timeframe. Alternatively, different portfolio models may be used for different specifications during the same timeframe. As another example and not by way of limitation, the portfolio model information may include an input of a portfolio model, such as an objective (e.g., risk profile objective, sector exposure objective), the set of candidate assets (e.g., determined in step 320), an output of a covariance matrix sub-model determined based on factor values of candidate assets, and/or other model inputs. As yet another example and not by way of limitation, the portfolio model information may include a portfolio model retraining frequency. The portfolio model information can be determined automatically, manually, predetermined, a combination thereof, and/or otherwise determined. However, the set of portfolio models can be otherwise determined.

The specification can additionally or alternatively include reallocation frequencies (e.g., how frequently the portfolio model is re-run to determine new asset allocations; how frequently the asset allocations should be updated; etc.), rebalancing frequencies (e.g., how frequently the assets should be traded to satisfy the asset allocations), tax harvesting goals, and/or other information. The platform can set the auxiliary specification information (e.g., standard values), manually determine, learn, and use rules or heuristics (e.g., based on objectives, etc.), and/or otherwise determine.

Although this disclosure describes determining the specification in particular manners, this disclosure contemplates determining the specification in any suitable manner.

As illustrated in FIG. 2B, method 200 can optionally include adding the determined specification (e.g., determined in step 210) to a series of specifications associated with the portfolio account.

### 2.5 Generate a Portfolio Model

Generating a portfolio model may function to determine the portfolio model to be used for asset portfolio determination. A single portfolio model may be determined for all users (e.g., all portfolio accounts), wherein multiple users share the same model. However, a different portfolio model can be generated for each user or subset. The portfolio model can be a regression model, a neural network, a decision tree, an optimization model (e.g., a multi-objective optimization algorithm, a single-objective optimization algorithm, etc.), and/or any other suitable model. Inputs of the portfolio model (e.g., during model training, during model inference, etc.) can include objectives (e.g., objective type, objective value), candidate assets, factors (e.g., factor values), uncertainty parameters (e.g., confidence intervals, confidence bands, etc.), and/or any other suitable inputs, such as model constraints (e.g., no short-selling, no accepting leverage, prohibiting any asset from having more than x % allocation, and so forth). Outputs of the portfolio model (e.g., during model training, during model inference) can include assets (e.g., asset identifiers for an asset portfolio), weight values (e.g., associated with assets), uncertainty parameters (e.g., confidence intervals, confidence bands, etc.), and/or any other suitable outputs. The portfolio model can optionally include one or more sub-models. For example, the portfolio model may include a covariance matrix sub-model that outputs an estimation of a covariance matrix of factors for candidate assets (e.g., to model the relationships between candidate assets). However, the portfolio model can include any other suitable sub-models. The portfolio model may be generated based on the portfolio information of the specification (e.g., determined in step 210 of FIG. 2A, FIG. 2B) but can additionally and/or alternatively be otherwise generated. The computer system can optionally store the portfolio model in a database (e.g., for future retrieval).

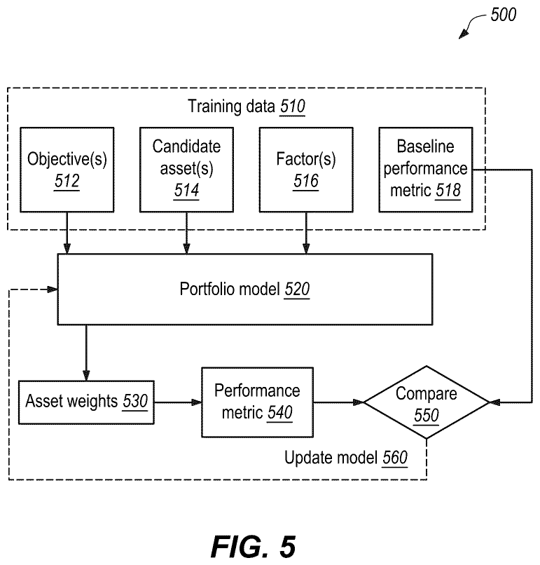

FIG. 5 illustrates an example flow diagram 500 for generating a portfolio model. In some embodiments, the portfolio model 520 can be generated (e.g., trained) based on a set of training data 510 (e.g., market data, factor data, etc.). The training data 510 can be synthetic data and/or real data. The training data 510 (e.g., raw data) can be pre-processed (e.g., data cleaning, data transformation, data reduction, etc.) or not be pre-processed. The training data 510 can be retrieved from a database, received from a third-party system, synthetically generated, and/or otherwise determined. In some embodiments, the computer system may generate objective(s) 512, candidate asset(s) 514, factor(s) 516, and baseline performance metric 518 from the training data 510.

As aforementioned, generating a portfolio model 520 can optionally include generating synthetic training data. Synthetic training data can include synthetic market data, synthetic factor data, and/or any other suitable data. For example, synthetic market data may include realizations of market data that mimic overall characteristics of real market data, benchmarked to a time period (e.g., the last 10 years), that have different distributions compared to real market data. However, the synthetic training data can be otherwise generated.

In some embodiments, the portfolio model 520 can be generated by training the portfolio model 520 on synthetic data and/or real data and/or otherwise generated. In an embodiment, objective(s) 512, candidate asset(s) 514, factor(s) 516, and baseline performance metric 518 may be fed into the portfolio model 520 during the training.

The computer system may determine a predicted asset portfolio using the portfolio model 520 based on synthetic data and/or real data. In an embodiment, the predicted asset portfolio may comprise asset weights 530. The computer system may then determine a predicted asset portfolio performance metric 540 based on the synthetic data and/or real data. The computer system may also determine a baseline asset portfolio performance metric 518 based on a baseline asset portfolio and the synthetic and/or real data. As an example and not by way of limitation, the performance metrics can include the Sharpe ratio, Sortino ratio, Treynor ratio, Calmar ratio, Martin ratio, upside potential ratio, information ratio, absolute return, and/or any other suitable performance metric. The computer system may update the portfolio model at step 560 based on comparison 550 between the predicted asset portfolio performance metric 540 and the baseline asset portfolio performance metric 518.

In some embodiments, all or a subset of the models described herein can include and/or leverage one or more of neural networks (e.g., CNN, DNN, transformer models, etc.), equations (e.g., weighted equations), regression (e.g., leverage regression), classification (e.g., leverage classification), rules, heuristics, statistical methods (e.g., probability), decision trees, and/or any other suitable model or methodology. The models can include (e.g., be constructed using) a set of input layers, output layers, and hidden layers (e.g., connected in series, such as in a feed-forward network, connected with a feedback loop between the output and the input, such as in a recurrent neural network; etc.; wherein the layer weights can be learned through training), a set of connected convolution layers (e.g., in a CNN), a set of self-attention layers, and/or have any other suitable architecture. The models can be retrieved from a repository, trained, received from a third-party system, and/or otherwise determined. The models can be trained, learned, fit, predetermined, and/or can be otherwise determined. The models can be trained using self-supervised, semi-supervised, supervised, unsupervised, transfer, reinforcement, and/or any other suitable training method. The models can be trained in-house, by a third party, and/or by any other suitable entity. The models can be trained hourly, daily (e.g., during trading days only), weekly, bi-weekly, monthly, and/or at any other suitable frequency. The system can include a different model for each user, a different model for each set of users, have a single model shared across all users, and/or be otherwise configured. The training target for the models can be binary, non-binary, numerical, categorical, and/or any other suitable characteristics. The training data 510 can be determined from synthetic and/or real data. The training data 510 can be determined from in-house data and/or third-party data.

In some embodiments, the portfolio model 520 may be trained daily (e.g., during trading days only) but can additionally and/or alternatively be trained hourly, weekly, bi-weekly, monthly, yearly, randomly, in response to receiving updated training data, and/or at any other suitable frequency and/or timing. The frequency of re-training the portfolio model 520 may be determined based on the specification (e.g., as in step 210 of FIG. 2A, FIG. 2B) but can additionally and/or alternatively be otherwise determined.

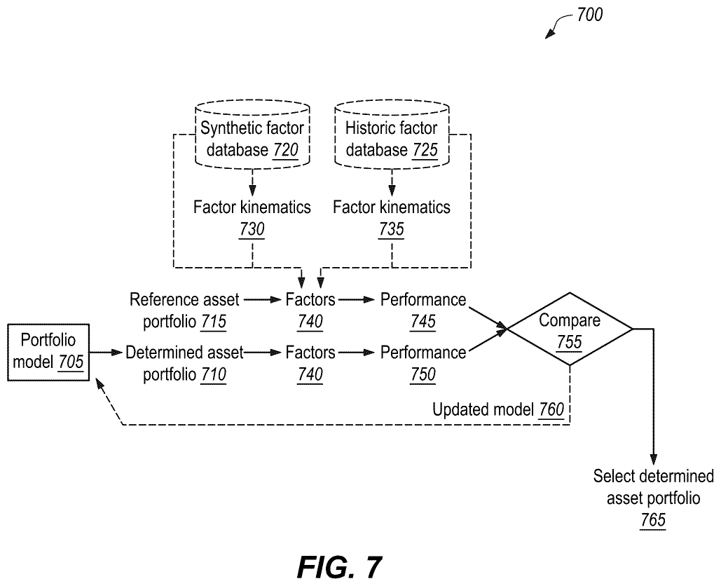

FIG. 7 illustrates an example method 700 for continuously re-training the portfolio model. Based on portfolio model 705, the computer system may generate a determined asset portfolio 710. The computer system may also access a reference asset portfolio 715. The computer system may generate factor kinematics 730 based on data from a synthetic factor database 720. In addition, the computer system may generate factor kinematics 735 based on data from a historic factor database 725. The computer system may further generate factors 740 based on both factor kinematics 730 and factor kinematics 735.

By evaluating the determined asset portfolio 710 against factors 740, the computer system may determine the performance 750 of the determined asset portfolio 710. Similarly, by evaluating the reference asset portfolio 715 against factors 740, the computer system may determine the performance 745 of the reference asset portfolio 715. The computer system may then compare 755 performance 750 with performance 745. If performance 750 is worse than performance 745, the computer system may update model 760.

A portfolio model 705 can be selected for use (and/or training can be halted for the training period) when the predicted asset portfolio's performance 750 exceeds a reference portfolio's performance 745 (e.g., based on one or more of the performance metrics discussed above; based on a set of objectives, etc.); when the predicted asset portfolio's performance distribution exceeds a reference portfolio's performance distribution; and/or when any other suitable condition is met., the computer system may select the determined asset portfolio 765 for subsequent tasks such as trading.

Although this disclosure describes generating a portfolio model in particular manners, this disclosure contemplates generating a portfolio model in any suitable manner.

### 2.6 Determine an Asset Portfolio

Determining an asset portfolio for the portfolio account based on the specification may function to determine an asset portfolio (e.g., a collection of assets) for the portfolio account associated with the user based on the specification (e.g., determined in step 210 of FIG. 2A, FIG. 2B). In some embodiments, the asset portfolio may include a set of assets and a weight value associated with each asset but can additionally and/or alternatively include only the set of assets, and/or any other suitable information. The asset portfolio may be determined based on a specification (e.g., objectives, candidate assets, portfolio models) but can additionally and/or alternatively be determined based on user input and/or any other suitable information. The asset portfolio may be determined automatically (e.g., using a portfolio model) but can additionally and/or alternatively be determined manually (e.g., by a user, an administrator, etc.), a combination thereof, and/or otherwise determined.

In an embodiment, determining an asset portfolio for the portfolio account based on the specification can include determining the asset portfolio based on the specification using a portfolio model (e.g., a regression, a neural network, etc.) that outputs asset weights. The portfolio model may be a portfolio model identified in the specification (e.g., the only model identified in the specification, selected from a set of portfolio models included in the specification, etc.) but can additionally and/or alternatively be any other suitable model. The portfolio model may be generated in-house as in step 220 of FIG. 2A or FIG. 2B but can additionally and/or alternatively be retrieved from a database, received from a third-party system, and/or otherwise determined. The portfolio model can predict a weight for each of a set of candidate assets (or asset classes) based on the factor values of candidate assets, covariances 430, uncertainties, and/or any other suitable information. The candidate asset set can be specified by the specification or determined based on the user's objectives and/or constraints (e.g., specified in the specification). In this embodiment, the predicted asset portfolio (e.g., asset allocation) can be immediately used or selected for use after validating performance superiority over a reference portfolio, such as the current asset portfolio (e.g., current asset allocation) or baseline asset portfolio (e.g., using the performance evaluation methods discussed above for portfolio model training), and/or used when any other suitable condition is met.

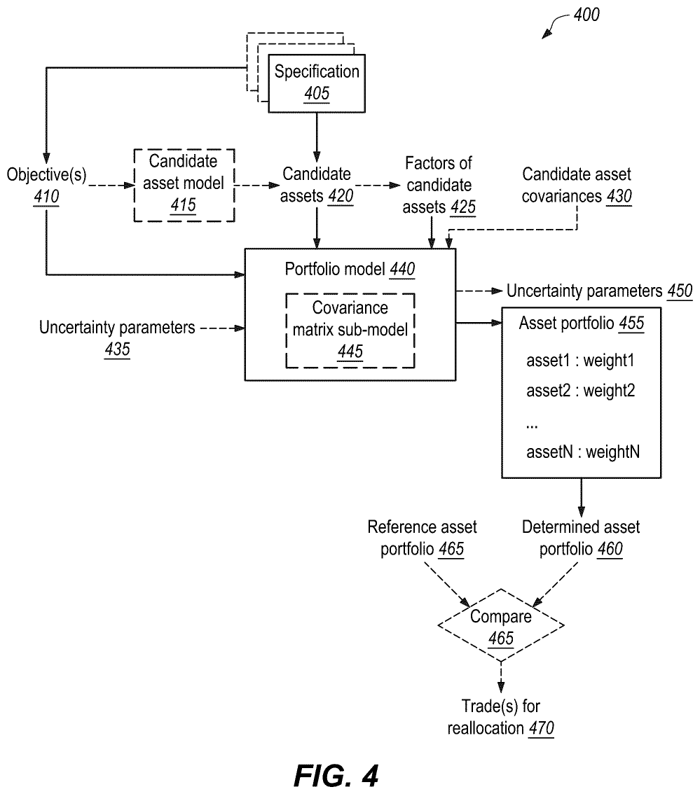

FIG. 4 illustrates an example flow diagram 400 for determining an asset portfolio for the portfolio account based on the specification. Based on specification 405, the computer system may determine objective(s) 410 and candidate assets 420. Optionally, the objective(s) 410 may be inputted into a candidate asset model 415, which may generate the candidate assets 420. Optionally, the computer system may determine factors of candidate assets 425 based on the candidate assets 420. The objective(s) 410 may be inputted into a portfolio model 440. In addition, the candidate assets 420 and factors of candidate assets 425 may be inputted into the portfolio model 440. Optionally, candidate asset covariances 430 and uncertainty parameters 435 may be inputted into the portfolio model 440. In some embodiments, the portfolio model 440 may include a covariance matrix sub-model 445. Based on the portfolio model 440, the computer system may determine an asset portfolio 455, which includes multiple assets, each having its own weight. Optionally, the portfolio model 440 may output updated uncertain parameters 450. The asset portfolio 455 may be a determined asset portfolio 460. Optionally, the computer system may compare (465) the determined asset portfolio 460 with a reference asset portfolio 465. If the performance of the determined asset portfolio 460 is better than the reference portfolio 465, the determined asset portfolio 460 may be used in trade(s) for reallocation 470.

In another embodiment, the asset portfolio may be determined by a user who, via a user interface, selects a set of assets from the set of candidate assets defined in the specification and assigns a weight to each asset of the set of assets.

In yet another embodiment, the asset portfolio may be determined by an administrator who evaluates the specification and determines the asset portfolio via a user interface.

Although this disclosure describes determining an asset portfolio in particular manners, this disclosure contemplates determining an asset portfolio in any suitable manner.

### 2.7 Use of Asset Portfolio

In some embodiments, the computer system may further execute a set of trades (e.g., buy and/or sell assets) for a current asset portfolio (e.g., for reallocation, rebalancing, etc.). The set of trades may be determined based on a comparison between the predicted asset portfolio (e.g., determined in step 230 of FIG. 2A, FIG. 2B) and a current asset portfolio but can additionally and/or alternatively be determined based on a price of an asset, a change in the price of an asset, a specification (e.g., determined in step 210 of FIG. 2A, FIG. 2B), portfolio account settings, user preferences (e.g., FIFO or LIFO trade sell), a user input, tax lot information (e.g., purchase date, number of shares, purchase price, holding period, cost basis etc.), and/or otherwise determined. Executing a trade can comprise forming an order and transmitting a parameterized request or programmatic call to an application programming interface (API) of a server computer that implements a trading platform, trading system, or trading desk. Multiple API calls that encapsulate a series of requests, each for a different trade and with parameters or attributes such as ticker symbol, unit quantity, offer price, or other parameters can be transmitted serially.

The computer system may execute the set of trades in response to the predicted asset portfolio but can additionally and/or alternatively in response to a change in the price of an asset at random times, daily, and/or at any other suitable frequency and/or time. The trades may be determined automatically (e.g., using an optimizer, using rules, etc.) but can additionally and/or alternatively be determined manually and/or otherwise. The set of trades may be executed automatically but can additionally and/or alternatively be executed manually and/or otherwise executed.

In an embodiment, executing the set of trades for a current asset portfolio can include the following steps. The computer system may first determine a set of trades based on a difference between the asset weights within the predicted asset portfolio and the asset weights within the current asset portfolio. The computer system may then execute the set of trades for reallocation of the current asset portfolio. As an example and not by way of limitation, the current asset portfolio may include 50% of the total portfolio value in AAPL (Apple stock) and 50% of the total portfolio value in GOOGL (Alphabet stock), and the predicted asset portfolio may include 75% of the total portfolio value in AAPL and 25% of the total portfolio value in GOOGL. The set of trades may include buying shares of AAPL and selling shares of GOOGL such that the current asset portfolio includes 75% of the total portfolio value in AAPL and 25% of the total portfolio value in GOOGL.

In an embodiment, trade and order generation processes can be programmed to enforce member-specific or user-specific constraints. For example, suppose a target allocation comprises 50% AAPL and 50% GOOG for a particular member, but the member also brought in NVDA stocks via an ACATS transfer and does not want the system to liquidate more than X % of NVDA. In response, the processes can be programmed to generate orders that attempt to target 50% AAPL & 50% GOOG without liquidating more than X % of the NVDA position. Digitally stored member-specific metadata can define rules, heuristics, or constraints that the programmed processes retrieve and enforce while generating orders or trades.

In another embodiment, executing the trades for a current asset portfolio can include the following steps. The computer system may firstly determine a set of trades based on a change in the price of an asset within the current asset portfolio and optionally tax lot information (e.g., purchase date, number of shares, purchase price, holding period, cost basis, etc.). The computer system may then execute the trades to rebalance the current asset portfolio. In this embodiment, determining the set of trades based on tax lot information can account for tax-loss harvesting, capital gains (e.g., long-term capital gains, short-term capital gains, etc.), and/or any other suitable tax-efficient strategies. As an example and not by way of limitation, the current asset portfolio is supposed to include 50% of total portfolio value in AAPL (Apple stock) and 50% of total portfolio value in GOOGL (Alphabet stock), but the current asset portfolio includes 55% of total portfolio value in AAPL and 45% of total portfolio value in GOOGL as a result of a price increase in AAPL. The trades may include selling shares of AAPL such that the current asset portfolio remains at 50% of the total portfolio value in AAPL and 50% of the total portfolio value in GOOGL.

Although this disclosure describes executing a set of trades in particular manners, this disclosure contemplates executing a set of trades in any suitable manner.

In some embodiments, the computer system may further track portfolio account history. The portfolio account history may be tracked based on a series of specifications but can additionally and/or alternatively be tracked based on portfolio account settings, user input, and/or otherwise tracked. As an example and not by way of limitation, tracking portfolio account history can include retrieving a series of specifications associated with the portfolio account for the user (e.g., in response to a third-party requesting for portfolio account history for the user as a result of compliance purposes), and evaluating the series of specifications to determine portfolio history analysis (e.g., to track history of portfolio models and/or asset portfolios developed for the user) using a portfolio history analysis model.

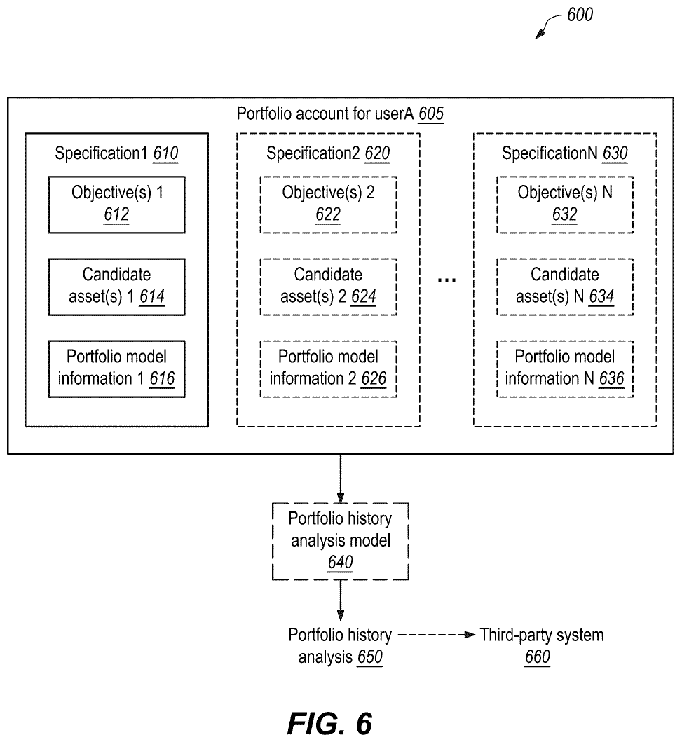

FIG. 6 illustrates an example flow diagram 600 for tracking portfolio account history. As shown in FIG. 6, the portfolio account for a first user 605 (also labeled “userA”) may include multiple specifications, e.g., specification1 610, specification2 620, and specification 630. Each specification may include its objective(s), candidate asset(s), and portfolio model information. For example, specification1 610 includes objective(s) 1 612, candidate asset(s) 1 614, and portfolio model information 1 616; specification2 620 includes objective(s) 2 622, candidate asset(s) 2 624, and portfolio model information 2 626; and specificationN 630 includes objective(s) N 632, candidate asset(s) N 634, and portfolio model information N 636. The portfolio account for the user 605 may be inputted into a portfolio history analysis model 640, which may generate a portfolio history analysis 650. Optionally, the portfolio history analysis 650 may be provided to a third-party system 660.

Although this disclosure describes tracking portfolio account history in particular manners, this disclosure contemplates tracking portfolio account history in any suitable manner.

### 3. Implementation Example—Hardware Overview

According to one embodiment, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. To accomplish the described techniques, such computing devices may also combine custom hard-wired logic, ASICs, or FPGAs with custom programming. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

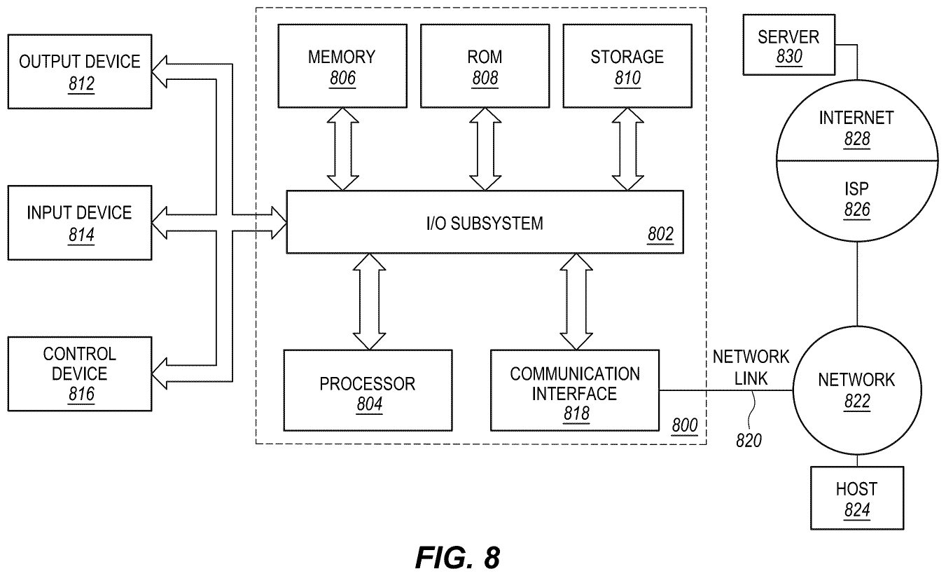

FIG. 8 is a block diagram that illustrates an example computer system with which an embodiment may be implemented. In the example of FIG. 8, a computer system 800 and instructions for implementing the disclosed technologies in hardware, software, or a combination of hardware and software are represented schematically, for example, as boxes and circles, at the same level of detail that is commonly used by persons of ordinary skill in the art to which this disclosure pertains for communicating about computer architecture and computer systems implementations.

Computer system 800 includes an input/output (I/O) subsystem 802, which may include a bus and/or other communication mechanisms for communicating information and/or instructions between the components of the computer system 800 over electronic signal paths. The I/O subsystem 802 may include an I/O controller, a memory controller, and at least one I/O port. The electronic signal paths are represented schematically in the drawings, for example, as lines, unidirectional arrows, or bidirectional arrows.

At least one hardware processor 804 is coupled to I/O subsystem 802 for processing information and instructions. Hardware processor 804 may include, for example, a general-purpose microprocessor or microcontroller and/or a special-purpose microprocessor such as an embedded system, a graphics processing unit (GPU), a digital signal processor, or an ARM processor. Processor 804 may comprise an integrated arithmetic logic unit (ALU) or may be coupled to a separate ALU.

Computer system 800 includes one or more units of memory 806, such as a main memory, which is coupled to I/O subsystem 802 for electronically digitally storing data and instructions to be executed by processor 804. Memory 806 may include volatile memory, such as various forms of random-access memory (RAM) or another dynamic storage device. Memory 806 may also be used to store temporary variables or other intermediate information during the execution of instructions to be executed by processor 804. Such instructions, when stored in non-transitory computer-readable storage media accessible to processor 804, can render computer system 800 into a special-purpose machine that is customized to perform the operations specified in the instructions.

Computer system 800 further includes non-volatile memory such as read-only memory (ROM) 808 or other static storage devices coupled to I/O subsystem 802 for storing information and instructions for processor 804. The ROM 808 may include various forms of programmable ROM (PROM), such as erasable PROM (EPROM) or electrically erasable PROM (EEPROM). A unit of persistent storage 810 may include various forms of non-volatile RAM (NVRAM), such as FLASH memory, solid-state storage, magnetic disk, or optical disks such as CD-ROM or DVD-ROM and may be coupled to I/O subsystem 802 for storing information and instructions. Storage 810 is an example of a non-transitory computer-readable medium that may be used to store instructions and data, which, when executed by processor 804, causes performing computer-implemented methods to execute the techniques herein.

The instructions in memory 806, ROM 808, or storage 810 may comprise one or more sets of instructions that are organized as modules, methods, objects, functions, routines, or calls. The instructions may be organized into one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation layer, application layer, and data storage layer, such as a relational database system using a structured query language (SQL) or no SQL, an object store, a graph database, a flat-file system, or other data storage.

Computer system 800 may be coupled via I/O subsystem 802 to at least one output device 812. In one embodiment, output device 812 is a digital computer display. Examples of a display that may be used in various embodiments include a touchscreen display, a light-emitting diode (LED) display, a liquid crystal display (LCD), or an e-paper display. Computer system 800 may include another type(s) of output devices 812, alternatively or in addition to a display device. Examples of other output devices 812 include printers, ticket printers, plotters, projectors, sound cards or video cards, speakers, buzzers or piezoelectric devices or other audible devices, lamps or LED or LCD indicators, haptic devices, actuators, or servos.

At least one input device 814 is coupled to I/O subsystem 802 for communicating signals, data, command selections, or gestures to processor 804. Examples of input devices 814 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 816, which may perform cursor control or other automated control functions such as navigation in a graphical interface on a display screen, alternatively or in addition to input functions. The control device 816 may be a touchpad, a mouse, a trackball, or cursor direction keys for communicating direction information and command selections to processor 804 and for controlling cursor movement on an output device 812, such as a display. The input device may have at least two degrees of freedom in two axes, a first axis (for example, x) and a second axis (for example, y), that allows the device to specify positions in a plane. Another type of input device is a wired, wireless, or optical control device, such as a joystick, wand, console, steering wheel, pedal, gearshift mechanism, or another type of control device. An input device 814 may include a combination of multiple different input devices, such as a video camera and a depth sensor.

In another embodiment, computer system 800 may comprise an Internet of Things (IoT) device in which one or more of the output device 812, input device 814, and control device 816 are omitted. Or, in such an embodiment, the input device 814 may comprise one or more cameras, motion detectors, thermometers, microphones, seismic detectors, other sensors or detectors, measurement devices or encoders, and the output device 812 may comprise a special-purpose display such as a single-line LED or LCD display, one or more indicators, a display panel, a meter, a valve, a solenoid, an actuator or a servo.

When computer system 800 is a mobile computing device, input device 814 may comprise a global positioning system (GPS) receiver coupled to a GPS module that is capable of triangulating to a plurality of GPS satellites, determining and generating geo-location or position data such as latitude-longitude values for a geophysical location of the computer system 800. Output device 812 may include hardware, software, firmware, and interfaces for generating position reporting packets, notifications, pulse or heartbeat signals, or other recurring data transmissions that specify a position of the computer system 800, alone or in combination with other application-specific data, directed toward host computer 824 or server computer 830.

Computer system 800 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 800 in response to processor 804 executing at least one sequence of at least one instruction contained in main memory 806. Such instructions may be read into main memory 806 from another storage medium, such as storage 810. Execution of the sequences of instructions contained in main memory 806 causes processor 804 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 810. Volatile media includes dynamic memory, such as memory 806. Common forms of storage media include, for example, a hard disk, solid-state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wires, and fiber optics, including the wires that comprise a bus of I/O subsystem 802. Transmission media can also be acoustic or light waves, such as those generated during radio-wave and infrared data communications.

Various forms of media may carry at least one sequence of at least one instruction to processor 804 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 800 can receive the data on the communication link and convert the data to a format that can be read by computer system 800. For instance, a receiver such as a radio frequency antenna or an infrared detector can receive the data carried in a wireless or optical signal, and appropriate circuitry can provide the data to I/O subsystem 802 and place the data on a bus. I/O subsystem 802 carries the data to memory 806, from which processor 804 retrieves and executes the instructions. The instructions received by memory 806 may optionally be stored on storage 810 before or after execution by processor 804.

Computer system 800 also includes a communication interface 818 coupled to I/O subsystem 802. Communication interface 818 provides a two-way data communication coupling to a network link(s) 820 directly or indirectly connected to at least one communication network, such as network 822 or a public or private cloud on the Internet. For example, communication interface 818 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 822 broadly represents a local area network (LAN), wide-area network (WAN), campus network, internetwork, or any combination thereof. Communication interface 818 may comprise a LAN card to provide a data communication connection to a compatible LAN or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 818 sends and receives electrical, electromagnetic, or optical signals over signal paths that carry digital data streams representing various types of information.

Network link 820 typically provides electrical, electromagnetic, or optical data communication directly or through at least one network to other data devices, using, for example, satellite, cellular, Wi-Fi, or BLUETOOTH technology. For example, network link 820 may connect through network 822 to a host computer 824.

Furthermore, network link 820 may provide a connection through network 822 or to other computing devices via internetworking devices and/or computers that are operated by an Internet Service Provider (ISP) 826. ISP 826 provides data communication services through a worldwide packet data communication network called Internet 828. A server computer 830 may be coupled to Internet 828. Server computer 830 broadly represents any computer, data center, virtual machine, or virtual computing instance with or without a hypervisor or computer executing a containerized program system such as DOCKER or KUBERNETES. Server computer 830 may represent an electronic digital service that is implemented using more than one computer or instance, and that is accessed and used by transmitting web services requests, uniform resource locator (URL) strings with parameters in HTTP payloads, API calls, app services calls, or other service calls. Computer system 800 and server computer 830 may form elements of a distributed computing system that includes other computers, a processing cluster, a server farm, or other organization of computers that cooperate to perform tasks or execute applications or services. Server computer 830 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 830 may comprise a web application server that hosts a presentation layer, application layer, and data storage layer, such as a relational database system using a structured query language (SQL) or no SQL, an object store, a graph database, a flat-file system or other data storage.

Computer system 800 can send messages and receive data and instructions, including program code, through the network(s), network link 820, and communication interface 818. In the Internet example, a server computer 830 might transmit a requested code for an application program through Internet 828, ISP 826, local network 822, and communication interface 818. The received code may be executed by processor 804 as it is received and/or stored in storage 810 or other non-volatile storage for later execution.

The execution of instructions, as described in this section, may implement a process in the form of an instance of a computer program that is being executed and consisting of program code and its current activity. Depending on the operating system (OS), a process may comprise multiple threads of execution that execute instructions concurrently. In this context, a computer program is a passive collection of instructions, while a process may execute those instructions. Several processes may be associated with the same program; for example, opening up several instances of the same program often means more than one process is being executed. Multitasking may be implemented to allow multiple processes to share processor 804. While each processor 804 or core of the processor executes a single task at a time, computer system 800 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims issued from this application in the specific form in which such claims issue, including any subsequent correction.

What is claimed is:

1. A computer-implemented method executed using a computer and comprising:
receiving a plurality of account specifications;
training a machine-learning model using training data derived from the account specifications to produce a trained machine-learning model capable of outputting a recommendation of a particular asset portfolio;
determining an asset portfolio by inputting a particular account specification into the machine-learning model;
determining a performance metric for the asset portfolio based on synthetic data and historic data associated with a plurality of assets;
determining a reference performance metric based on a reference asset portfolio and the synthetic and historic data;
comparing the performance metric for the asset portfolio with the reference performance metric to result in a decision of whether to re-train the machine-learning model;
re-training the machine-learning model based on updated training data and the synthetic and historic data;
automatically executing one or more trades for an updated asset portfolio determined by the re-trained machine-learning model; and
repeating the re-training of the machine-learning model continuously based on a specified frequency or timing.

2. The computer-implemented method of claim 1, wherein each account specification comprises one or more of an objective, an uncertainty parameter, an account setting, a user preference, a candidate asset, model information associated with the machine-learning model, a reallocation frequency, a rebalancing frequency, or a tax harvesting goal.

3. The computer-implemented method of claim 1, wherein each account specification is associated with a time.

4. The computer-implemented method of claim 1, wherein the asset portfolio comprises one or more assets, each of the assets being associated with one or more of a weight value, a monetary value, an asset type, an asset identifier, a factor, or a factor value.

5. The computer-implemented method of claim 4 further comprising:
determining a plurality of candidate assets based on one or more objectives and one or more criteria; and
selecting the one or more assets from the plurality of candidate assets.

6. The computer-implemented method of claim 1 further comprising:
generating one or more factors based on the synthetic and historic data; and
determining the performance metric for the asset portfolio and the reference performance metric based on the one or more factors.

7. The computer-implemented method of claim 1, wherein the synthetic data comprises synthetic market data comprising realizations of market data that mimic overall characteristics of real market data, wherein the realizations of market data have been benchmarked to a time period, and wherein the realizations of market data have different distributions compared to the real market data.

8. The computer-implemented method of claim 1, wherein the performance metric comprises one or more of Sharpe ratio, Sortino ratio, Treynor ratio, Calmar ratio, Martin ratio, upside potential ratio, information ratio, or absolute return.

9. The computer-implemented method of claim 1 further comprising comparing the performance metric for the asset portfolio with the reference performance metric to result in a decision to re-train the machine-learning model based on the reference performance exceeding the performance metric for the asset portfolio.

10. The computer-implemented method of claim 1 further comprising:
comparing the performance metric for the asset portfolio with the reference performance metric based on the performance metric for the asset portfolio exceeding the reference performance metric to result in a decision to not re-train the machine-learning model; and
selecting the asset portfolio for executing the one or more trades.

11. The computer-implemented method of claim 1 further comprising determining the specified frequency or timing based on the particular account specification.

12. The computer-implemented method of claim 1 further comprising:
determining one or more objectives associated with the particular account specification; and
comparing the asset portfolio with the reference asset portfolio based on the objectives to result in a decision of whether to re-train the machine-learning model.

13. The computer-implemented method of claim 1 further comprising:
determining a performance distribution associated with the asset portfolio;
determining a reference performance distribution associated with the reference asset portfolio; and
comparing the performance distribution associated with the asset portfolio with the reference performance distribution to result in a decision of whether to re-train the machine-learning model.

14. One or more non-transitory computer-readable storage media storing one or more sequences of instructions which, when executed using one or more processors, cause the one or more processors to execute:
receiving a plurality of account specifications;
training a machine-learning model using training data derived from the account specifications to produce a trained machine-learning model capable of outputting a recommendation of a particular asset portfolio;
determining an asset portfolio by inputting a particular account specification into the machine-learning model;
determining a performance metric for the asset portfolio based on synthetic data and historic data associated with a plurality of assets;
determining a reference performance metric based on a reference asset portfolio and the synthetic and historic data;
comparing the performance metric for the asset portfolio with the reference performance metric to result in a decision of whether to re-train the machine-learning model;
re-training the machine-learning model based on updated training data and the synthetic and historic data;
automatically executing one or more trades for an updated asset portfolio determined by the re-trained machine-learning model; and
repeating the re-training of the machine-learning model continuously based on a specified frequency or timing.

15. The one or more non-transitory computer-readable storage media of claim 14, wherein each account specification comprises one or more of an objective, an uncertainty parameter, an account setting, a user preference, a candidate asset, model information associated with the machine-learning model, a reallocation frequency, a rebalancing frequency, or a tax harvesting goal.

16. The one or more non-transitory computer-readable storage media of claim 14, wherein each account specification is associated with a time.

17. The one or more non-transitory computer-readable storage media of claim 14, wherein the asset portfolio comprises one or more assets, each of the assets being associated with one or more of a weight value, a monetary value, an asset type, an asset identifier, a factor, or a factor value.

18. The one or more non-transitory computer-readable storage media of claim 4 further comprising sequences of instructions which, when executed using the one or more processors, cause the one or more processors to execute:
determining a plurality of candidate assets based on one or more objectives and one or more criteria; and
selecting the one or more assets from the plurality of candidate assets.

19. The one or more non-transitory computer-readable storage media of claim 14 further comprising sequences of instructions which, when executed using the one or more processors, cause the one or more processors to execute:
generating one or more factors based on the synthetic and historic data; and
determining the performance metric for the asset portfolio and the reference performance metric based on the one or more factors.

20. The one or more non-transitory computer-readable storage media of claim 14, wherein the synthetic data comprises synthetic market data comprising realizations of market data that mimic overall characteristics of real market data, wherein the realizations of market data have been benchmarked to a time period, and wherein the realizations of market data have different distributions compared to the real market data.

21. The one or more non-transitory computer-readable storage media of claim 14, wherein the performance metric comprises one or more of Sharpe ratio, Sortino ratio, Treynor ratio, Calmar ratio, Martin ratio, upside potential ratio, information ratio, or absolute return.

22. The one or more non-transitory computer-readable storage media of claim 14 further comprising sequences of instructions which, when executed using the one or more processors, cause the one or more processors to execute comparing the performance metric for the asset portfolio with the reference performance metric to result in a decision to re-train the machine-learning model based on the reference performance exceeding the performance metric for the asset portfolio.

23. The one or more non-transitory computer-readable storage media of claim 14 further comprising sequences of instructions which, when executed using the one or more processors, cause the one or more processors to execute:
comparing the performance metric for the asset portfolio with the reference performance metric based on the performance metric for the asset portfolio exceeding the reference performance metric to result in a decision to not re-train the machine-learning model; and
selecting the asset portfolio for executing the one or more trades.

24. The one or more non-transitory computer-readable storage media of claim 14 further comprising sequences of instructions which, when executed using the one or more processors, cause the one or more processors to execute determining the specified frequency or timing based on the particular account specification.

25. The one or more non-transitory computer-readable storage media of claim 14 further comprising sequences of instructions which, when executed using the one or more processors, cause the one or more processors to execute:
determining one or more objectives associated with the particular account specification; and
comparing the asset portfolio with the reference asset portfolio based on the objectives to result in a decision of whether to re-train the machine-learning model.

26. The one or more non-transitory computer-readable storage media of claim 14 further comprising sequences of instructions which, when executed using the one or more processors, cause the one or more processors to execute:
determining a performance distribution associated with the asset portfolio;
determining a reference performance distribution associated with the reference asset portfolio; and
comparing the performance distribution associated with the asset portfolio with the reference performance distribution to result in a decision of whether to re-train the machine-learning model.
